(19) United States
(12) Patent Application Publication
(10) Pub. No.: US 2002/0150284 A1
(43) Pub. Date: Oct. 17, 2002

(54) Fingerprint recognition device and fingerprint recognition method

(76) Inventor: Hajimu Iwai, Kyoto-shi (JP)

Correspondence Address: DICKSTEIN SHAPIRO MORIN & OSHINSKY LLP, 2101 L STREET NW, WASHINGTON, DC, 20037-1526, US

(21) Appl. No.: 10/119,723

(22) Filed: Apr. 11, 2002

(30) Foreign Application Priority Data
Apr. 16, 2001 (JP) 116412/2001

(51) Int. Cl. G06K 9/00

(52) U.S. Cl. 382/124

(57) ABSTRACT

The present invention relates to a fingerprint recognition device, which can be made thinner and less expensive. A light-guide plate 2 guides light entering from an end face. A transmission liquid-crystal plate 1 is opened by pixel unit. Light from the protruding portions 31A and recessed portions 31B constituting the fingerprint of a finger 31 is collected via on aperture of transmission liquid-crystal plate 1, and converted from light energy to electrical energy by a photodetector element. The present invention is applicable to a fingerprint recognition device.

### BACKGROUND OF THE INVENTION

1. Field of the Invention

The present invention relates to a fingerprint recognition device and fingerprint recognition method, and more particularly to a low-cost, reduced-thickness fingerprint recognition device and a fingerprint recognition method.

2. Description of the Related Art

Various apparatus have been proposed in the past as apparatus for inputting fingerprint images.

In Japanese Patent Laid-open No. 2000-30034, there is disclosed a constitution in which one liquid-crystal plate (a second liquid-crystal plate) is arranged on top of one light-guide plate (a first light-guide plate), and on top of this second liquid-crystal plate is further arranged one more light-guide plate (a second light-guide plate) and one more liquid-crystal plate (a second liquid crystal plate). In this constitution, incoming light from the one end face of the bottommost first light-guide plate travels and is guided through the inside portion of the first light-guide plate. Light traveling through this first light-guide plate is transmitted through a predetermined part of the first liquid-crystal plate thereabove, and enters the inside of another second light-guide plate. The light entering this second light-guide plate is irradiated via the second liquid-crystal plate onto a finger placed on top of the second liquid-crystal plate.

Light reflected by the finger returns inside the second light-guide plate, travels therethrough, and is emitted from an end face. The emitted light is intercepted by a photodetector element, and an image of the fingerprint of the finger is read from the output of the photodetector element.

Thus, in the invention disclosed in the above-mentioned publication, the problems were that, because two light-guide plates and two liquid-crystal plates were used, it was difficult to reduce thickness, and the cost was high.

### SUMMARY OF THE INVENTION

With the foregoing in view, it is an object of the present invention to provide a fingerprint recognition device, which is low cost and is capable of being made thin.

A fingerprint recognition device of the present invention is characterized in that it comprises: a window member on which a finger is placed; a first light source device for generating a light, which is irradiated on a finger placed on a window member; a liquid-crystal plate for sequentially transmitting, one pixel at a time, light from a finger placed on a window member by sequentially moving the location of an aperture; a light-collecting portion for collecting light from a liquid-crystal plate; and a photodetector element for receiving light, by pixel unit, collected by a light-collecting portion.

The above-mentioned liquid-crystal plate is capable of transmitting either light, which has been reflected by a finger, or light, which has been diffused by a finger.

When light is to be reflected by a finger, for example, it is possible to employ a constitution such that light, which is emitted from a first light source via a window member, illuminates a finger and is reflected by the surface of the finger, and when light is to be diffused by a finger, for example, it is possible to employ a constitution such that light from a first light source is illuminated directly onto a finger, passes through the inside of the finger, and is diffused by the surface of the finger.

Light generated by a first light source device is irradiated on a finger. A liquid-crystal plate transmits light from a finger by pixel unit, and this light is incident on a photodetector element by way of a light-collecting portion.

Therefore, it is possible to realize a fingerprint recognition device, which can be made thin and inexpensive.

For example, the window member used here is constituted by a flat-shaped window member on which is placed a finger, which has the fingerprint to be read, the first light source is constituted by an LED, the liquid-crystal plate is constituted by a transmission liquid-crystal plate, the light-collecting portion is constituted by either a conicalor parabola-shaped light-collecting portion, or an optical fiber, and the photodetector element is constituted by a photodetector element having a function for converting one pixel's worth of light from light energy to electrical energy.

As for the above-mentioned window member, in addition to having a finger placed on the surface thereof, a light-guide plate for guiding light, which is generated by the above-mentioned first light source device and enters inside the light-guide plate, can be provided.

Thus, by providing a light-guide plate, it is possible to illuminate a finger reliably and with sufficient brightness. Further, a light-guide plate can be provided for each window member the same as a liquid-crystal plate, enabling the realization of a thin, inexpensive apparatus.

Further, when an image of a fingerprint is formed on an image pickup element via a lens and read, the image is distorted, and it becomes difficult to read the fingerprint accurately, but in the case of the present invention, since there is no image distortion, accurate reading becomes possible. Therefore, it is possible to improve the fingerprint identification ratio.

This light-guide plate, for example, is constituted from either a flat light-guide plate or a prism.

In the above-mentioned light-guide plate, a practically transparent gel-like thin-film layer can be formed on the surface upon which the above-mentioned finger is placed.

By forming a thin-film layer, an image of the protruding portions and recessed portions of a fingerprint can be captured more clearly.

This thin-film layer, for example, is constituted by a gel film, which is constituted by a silicone thin film or the like.

Storing means for storing the output of the above-mentioned photodetector element by pixel unit corresponding to the pixels of a liquid-crystal plate can also be provided.

Storing means store photodetector element output by pixel unit. Therefore, an image corresponding to a fingerprint image of a finger is stored in storing means. This storing means, for example, is constituted by a SRAM (static random access memory).

The present invention can be constituted such that the above-mentioned liquid-crystal plate sequentially selects an arbitrary pixel from among a plurality of pixels arranged two-dimensionally as the above-mentioned aperture through which light from the above-mentioned finger passes. This liquid-crystal plate, for example, is constituted by a transmission liquid-crystal plate on which 4×6 pixels are arranged two-dimensionally (in a planar condition).

In this case, a liquid-crystal plate reads a fingerprint by the so-called area sensing mode.

Further, the present invention can be constituted such that the above-mentioned liquid-crystal plate sequentially selects an arbitrary pixel from among a plurality of pixels arranged one-dimensionally as the above-mentioned aperture through which light from the above-mentioned finger passes. This liquid-crystal plate, for example, is constituted by a transmission liquid-crystal plate on which 1×15 pixels are arranged one-dimensionally (linearly).

In this case, since a liquid-crystal plate reads a fingerprint by the so-called line sensing mode, the area of the fingerprint reading portion can be made smaller than when reading is performed using the area sensing mode, and mounting to electronic apparatus also becomes easier. Further, since it is possible to reduce the size of the liquid-crystal plate, which accounts for a large percentage of the cost of a fingerprint recognition device, costs can be lowered.

A second light source device for generating a light, which irradiates from the above-mentioned photodetector element toward the above-mentioned window member, can also be provided for the above-mentioned liquid-crystal plate, and the above-mentioned liquid-crystal plate can be constituted such that causing light from the above-mentioned second light source device to travel in the direction of the above-mentioned window member displays an image.

In this case, an image can be displayed on a liquid-crystal plate. Therefore, for example, a fingerprint image, inputting portion can be formed on an image displaying portion of an electronic apparatus. Thus, because a liquid-crystal plate can be used for both an image displaying function and a fingerprint image inputting function, it is possible to achieve parts aggregation and apparatus miniaturization.

This second light source device, for example, is constituted by a light-emitting element.

A fingerprint recognition method of the present invention is characterized in that, by irradiating light on a finger placed on a window member and sequentially shifting the location of the aperture of a liquid-crystal plate, light from a finger placed on a window member is allowed to sequentially pass through the aperture one pixel at a time, and the light from the liquid-crystal plate is collected, and the collected light is received by pixel unit.

### BRIEF DESCRIPTION OF THE DRAWINGS

FIG. 1 is a diagram showing an example of a constitution of a fingerprint recognition device applicable to the present invention;

FIG. 2 is an enlarged cross-sectional view showing a state in which a finger is being pressed against a light-guide plate;

FIG. 3 is a flowchart explaining the operation of the apparatus of FIG. 1;

FIG. 4 is a diagram illustrating the shifting of the aperture of a transmission liquid-crystal plate of FIG. 1;

FIG. 5 is a diagram showing an example of the results of a fingerprint reading;

FIG. 6 is a diagram showing an example of another constitution of a fingerprint recognition device applicable to the present invention;

FIG. 7 is a diagram showing a constitution of the transmission liquid-crystal plate of FIG. 6; and

FIG. 8 is a diagram showing an example of yet another constitution of a fingerprint recognition device applicable to the present invention.

### DETAILED DESCRIPTION OF THE PREFERRED EMBODIMENTS

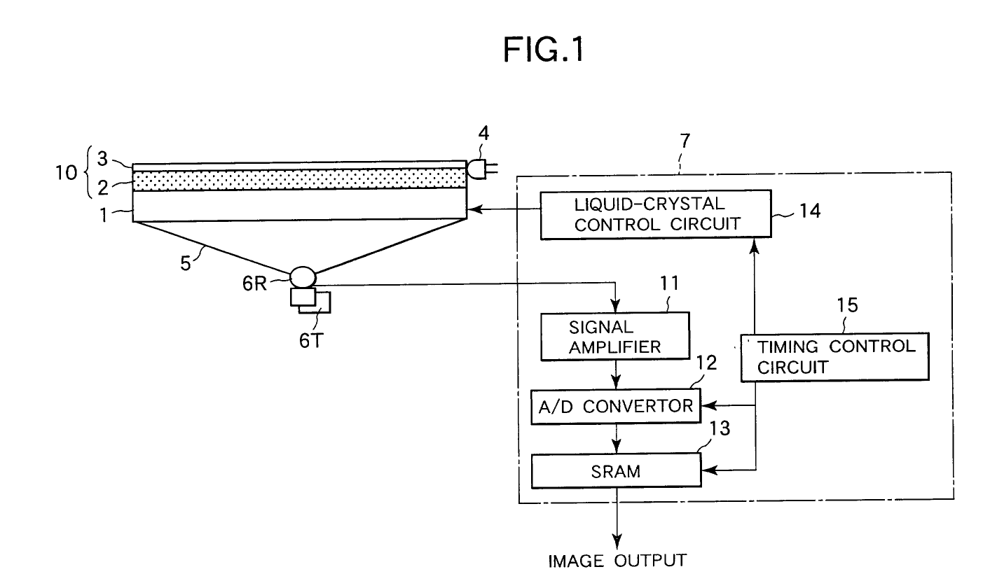

FIG. 1 shows an example of a constitution of a fingerprint recognition device applicable to the present invention. In the case of this example, a window member 10 on which a finger having a fingerprint to be read is placed, is constituted by a light-guide plate 2. On the surface of light-guide plate 2, for example, there is formed a gel film 3, which is constituted by a thin film of silicone or the like. This gel film 3 has softness, a portion of which penetrates into the recessed portions of a fingerprint when pressed by a finger, and, in addition, has functionality, which sufficiently propagates light (that is, it is required to be transparent).

On the bottom surface of light-guide plate 2, there is arranged a transmission liquid-crystal plate 1, which is constituted by arranging pixels two-dimensionally (in a planar condition). At the end face of transmission liquid-crystal plate 1 is arranged an LED (light emitting diode)4 as a light source device. Light emitted by LED 4 enters light-guide plate 2 and propagates through the inside thereof.

On the surface opposite the surface on which the light-guide plate 2 of transmission liquid-crystal plate 1 is formed, there is formed a light-collecting portion 5 of either a conical or parabola shape. Furthermore, this light-collecting portion 5 can also be constituted by an optical fiber. In accordance therewith, the present invention can be made even thinner. A photodetector element 6R is disposed in the center of light-collecting portion 5. This photodetector element 6R has functionality for converting one pixel's worth of light from light energy to electrical energy.

When an image is to be displayed on transmission liquid-crystal plate 1, a light-emitting element 6T is disposed in a location that practically corresponds with photodetector element 6R. Thus, light generated by light-emitting element 6T is incident on transmission liquid-crystal plate 1 via light-collecting portion 5. Therefore, by controlling the transmittancy of a predetermined pixel of transmission liquid-crystal plate 1 corresponding to an image, it is possible to display an image via transmission liquid-crystal plate 1.

Controlling circuit 7 has signal amplifier 11 for amplifying the output of photodetector element 6R. The output of signal amplifier 11 is converted from analog to digital by A/D converter 12, and thereafter, is inputted and stored in SRAM (Static Dynamic Random Access Memory) 13. Controlling circuit 7 also has a liquid-crystal control circuit 14, and this liquid-crystal control circuit 14 drives transmission liquid-crystal plate 1. A timing control circuit 15 supplies timing signals to A/D converter 12, SRAM 13, and liquid-crystal control circuit 14 for their control.

Image data read out from SRAM 13 is supplied to a microcomputer not shown in the figure, and utilized in fingerprint identification processing.

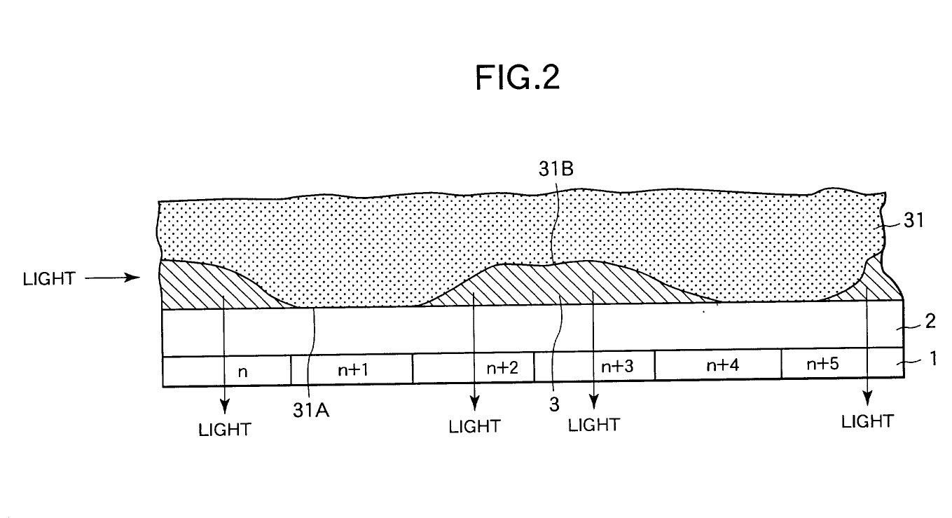

FIG. 2 shows an enlarged view of the state when a finger is placed on top of light-guide plate 2. When a finger 31 is placed on top of light-guide plate 2, due to its softness, gel film 3 is displaced, and the protruding portions 31A of the fingerprint of finger 31 make direct contact with light-guide plate 2. Further, a state is created in which gel film 3 fills in the recessed portions 31B of the fingerprint.

Light entering from the end face of light-guide plate 2 (hence, the end face of gel film 3) propagates inside light-guide plate 2 and gel film 3. In FIG. 2, when finger 31 is observed (it is supposed that all the pixels of transmission liquid-crystal plate 1 are now allowing light to pass through) from the bottom of the figure (from the transmission liquid-crystal plate 1 side), whereas light from gel film 3 is shut out for the parts corresponding to the protruding portions 31A, because light is propagating through the inside of gel film 3 for the parts corresponding to the recessed portions 31B, the parts of the recessed portions 31B are observed more brightly than the parts of the protruding portions 31A. Accordingly, a reading of the fingerprint image (the pattern formed by the protruding portions 31A and recessed portions 31B), can be made.

In the present invention, the transmission liquid-crystal plate 1 sequentially switches such that light passes through by pixel unit one pixel at a time (it switches such that the aperture shifts sequentially). The remainder of the pixels of transmission liquid-crystal plate 1 are controlled such that light does not pass through them. As a result, for example, in the example of FIG. 2, when pixel n is controlled so as to allow light to pass through (pixel n+1 through n+5 are controlled so as not to let light pass through), light propagating through light-guide plate 2 and gel film 3 passes through pixel n of transmission liquid-crystal plate 1. Similarly, when pixels n+2, n+3 and n+5 are set to a state in which light is allowed to pass through, light is outputted to the other side of transmission liquid-crystal plate 1. Contrary thereto, when pixels n+1 and n+4 are controlled to a state in which light is allowed to pass through them, respectively (when they are set as the apertures), because these locations correspond to protruding portions 31A of the fingerprint, light passing through the bottom of the figure from transmission liquid-crystal plate 1 is less than when pixel n, n+2, n+3 or n+5 is set as the aperture opening.

Light passing through transmission liquid-crystal plate 1 by pixel unit is collected by light-collecting portion 5, and made incident on photodetector element 6R. Therefore, it becomes possible to achieve a fingerprint image from the output of photodetector element 6R.

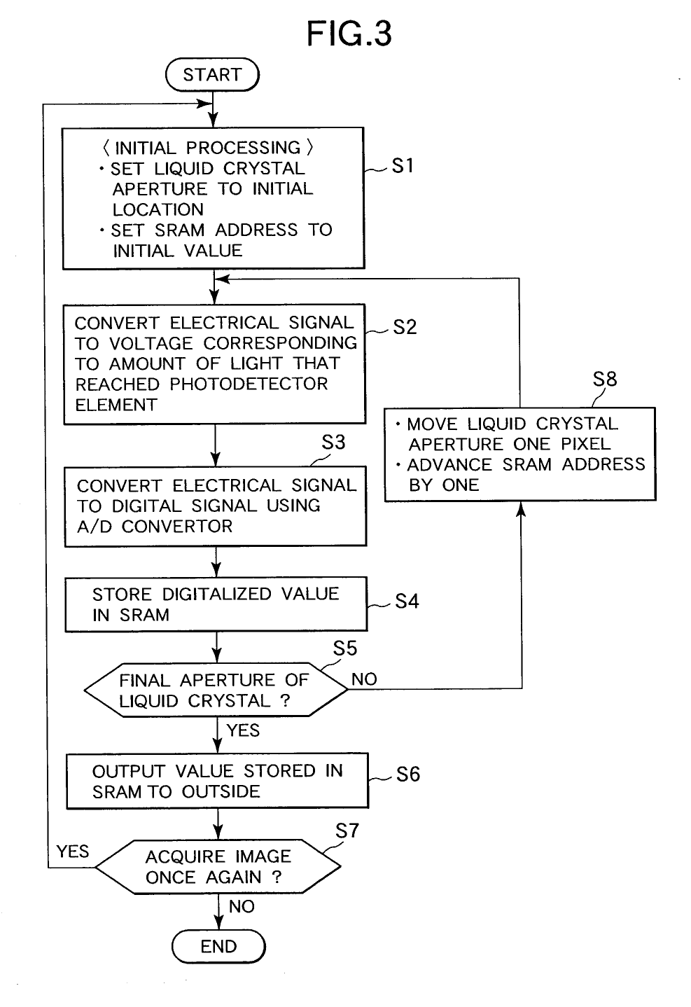

Next, the operation of the apparatus of FIG. 1 will be explained by referring to the flowchart of FIG. 3.

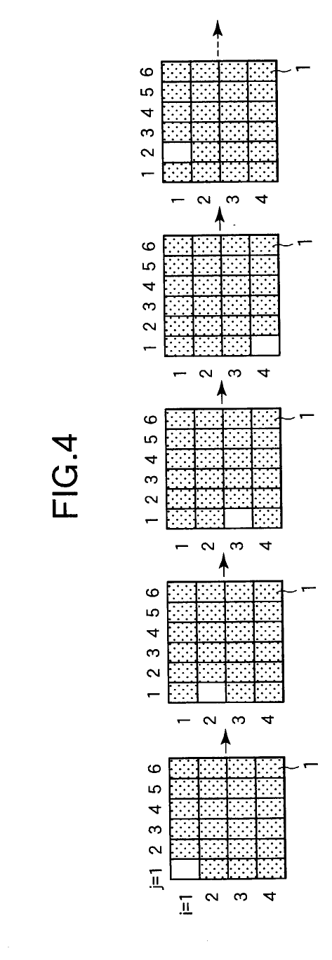

Firstly, in Step S1, initial processing is executed. That is, at this time, liquid-crystal control circuit 14 sets the aperture opening of transmission liquid-crystal plate 1 (the pixel through which light will pass) to the initial location. For example, as shown in FIG. 4, when transmission liquid-crystal plate 1 is constituted by arranging 4×6 pixels two-dimensionally (in a planar condition), the pixel of the upper left (1,1) is controlled such that light passes through (it is made the aperture). Then, the remaining 23 pixels are controlled so as not to allow light to pass through.

Further, in Step S1, timing control circuit 15 sets the SRAM 13 address to the initial value. That is, this address is set so as to store the pixel data of pixel (1,1) in FIG. 4.

Next, in Step S2, photodetector element 6R converts an electric signal, which corresponds to an amount of light that has arrived, to a voltage, and outputs the voltage.

That is, when a user presses a finger 31 onto light-guide plate 2, it constitutes the state explained by referring to FIG. 2. When pixel (1,1) corresponds to an recessed portion 31B of a fingerprint, as was the case for pixel n, for example, in FIG. 2, a stronger light is incident on photodetector element 6R via light-collecting portion 5. By contrast thereto, when pixel (1,1) corresponds to a protruding portion 31A of a fingerprint, as was the case for pixel n+1 in FIG. 2, the amount of light incident on photodetector element 6R via light-collecting portion 5 is less than when pixel (1,1) corresponds to an recessed portion 31B. Photodetector element 6R outputs a voltage, which corresponds to the amount of this incoming light.

Signal amplifier 11 amplifies the output of photodetector element 6R, and inputs this amplified output to A/D converter 12. In Step S3, A/D converter 12 converts the signal inputted from signal amplifier 11 from an analog signal to a digital signal. In Step S4, SRAM 13 stores a signal corresponding to this pixel (1,1) in the corresponding address.

Next, in Step S5, timing control circuit 15 determines whether or not the aperture has moved to the last aperture of transmission liquid-crystal plate 1. In the present case, the aperture has not yet moved to the final aperture. Accordingly, in this case, processing advances to Step S8, and timing control circuit 15 shifts the location of the aperture of transmission liquid-crystal plate 1 by one to the next scan location. In the case of the example of FIG. 4, the aperture is moved by one to the bottom side location. That is, the aperture is moved from the pixel of (1,1) to the pixel of (2,1). The timing control circuit 15 also converts the address of SRAM 13 corresponding to the shifting of the aperture.

Next, processing returns to Step S2, and the same processing as that described hereinabove is executed. That is, in accordance therewith, the pixel data of pixel (2,1) is stored in SRAM 13.

Thereafter, the same processing is repeated sequentially, the aperture is sequentially shifted from pixel (3,1), (4,1), (1,2) . . . as shown in FIG. 4, and the corresponding pixel data is supplied to and stored in SRAM 13 one pixel at a time. That is, in this example, area sensing processing is performed.

In Step S5, when it is determined that aperture 6 has moved to pixel (4,6), since this is the final aperture, processing proceeds to Step S6, and timing control circuit 15 outputs pixel data stored in SRAM 13 to the outside. That is, in accordance therewith, image data read from a user's fingerprint is transmitted to a microcomputer or the like. The microcomputer compares this data against fingerprint data registered beforehand, and if both sets of data match, the microcomputer outputs authentication OK, and if the two do not match up, it outputs authentication NG.

In Step S7, timing control circuit 15 determines whether an image should be acquired once again (whether or not to read a fingerprint), and when reading is to be performed, processing returns to Step S1, and processing subsequent thereto is repeated and executed. When a determination is made that an image need not be acquired again, processing is terminated.

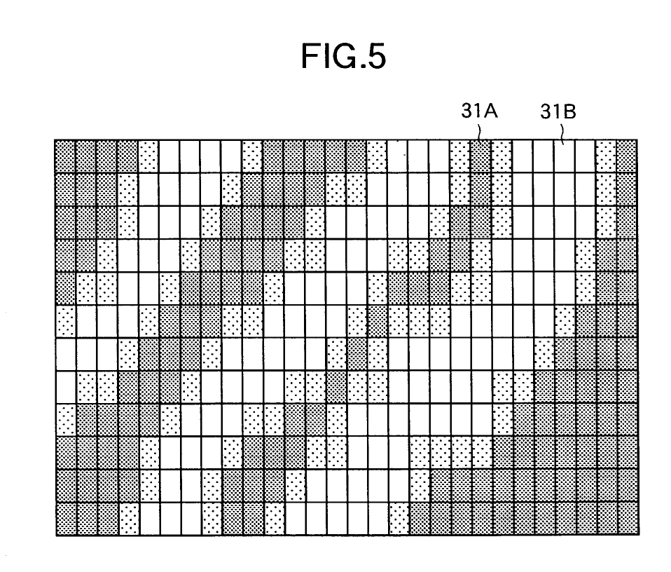

FIG. 5 shows an example of the results of fingerprint reading as described hereinabove. In the figure, the parts shown in white are the bright parts, and correspond to the recessed portions 31B of a fingerprint. By contrast, the parts in the figure displayed in black correspond to the protruding portions 31A of the fingerprint.

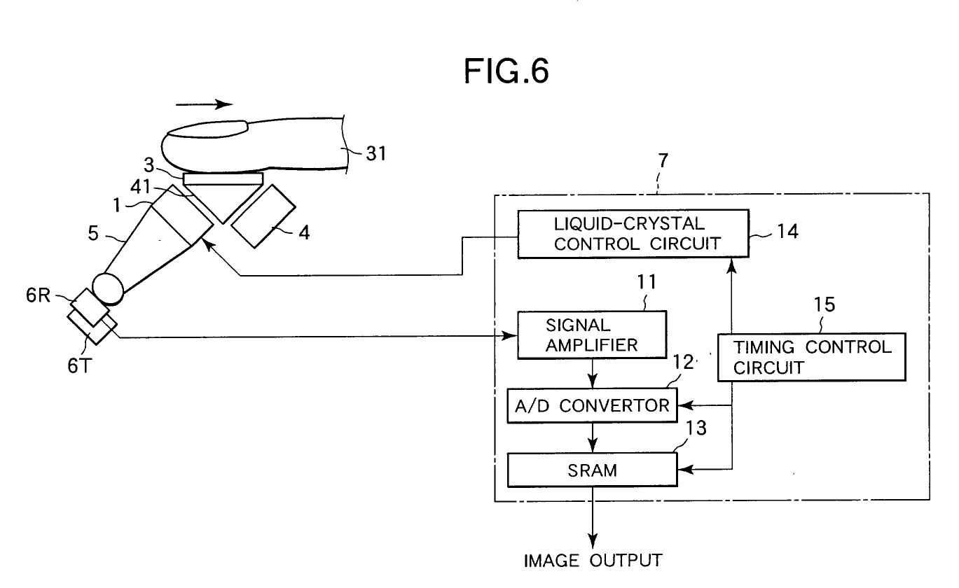

FIG. 6 shows another aspect of the embodiment. In this aspect of the embodiment, light-guide plate 2 in the aspect of the embodiment of FIG. 1 is constituted by a prism 41. On the surface of the prism 41 with which a finger 31 makes contact, a gel film 3 is formed the same as in the case of the aspect of the embodiment of FIG. 1. LED 4 irradiates light from a cross-section of one side of prism 41, illuminating a finger 31 via gel film 3.

The pixels of this transmission liquid-crystal plate 1 are arranged one-dimensionally (linearly). The rest of the constitution is the same as the case in FIG. 1.

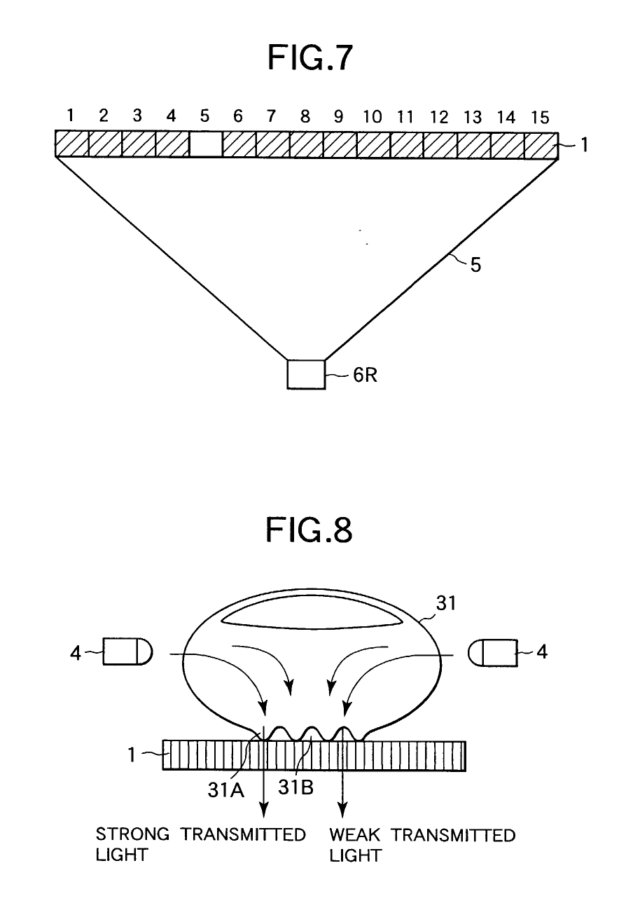

Thus, in the case of this aspect of the embodiment, as shown in FIG. 7, transmission liquid-crystal plate 1 is constituted from 1×n (in the case of the example of FIG. 7, n=15) pixels. Liquid-crystal control circuit 14 shifts the aperture sequentially one pixel at a time from number 1 to number 15 in transmission liquid-crystal plate 1. That is, in this example, line sensing processing is performed. Thus, pixels in the line direction (the horizontal direction in FIG. 7) can be read, but pixels in the orthogonal direction (in FIG. 7, pixels in the vertical direction) cannot be read. Accordingly, in this case, as shown in FIG. 6, a user moves a finger 31 on top of prism 41 in the direction of the arrow in the figure. As a result thereof, in FIG. 7, finger 31 moves either in the direction from top to bottom, or in the direction from bottom to top. In accordance therewith, photodetector element 6R can read an image of the surface of a fingerprint the same as in the aspect of the embodiment of FIG. 1.

In the above explanation, gel film 3 is formed on the surface of light-guide plate 2, but it is possible to read an image of a fingerprint even without forming gel film 3. However, forming gel film 3 enables the reading of a higher contrast fingerprint image.

Furthermore, as shown in FIG. 8, the present invention can also be constituted such that both light-guide plate 2 and gel film 3 are omitted, and a finger 31 is directly illuminated by light from LED 4. In this case, since light, which passes through the inside of finger 31 and is diffused by the surface of the finger, is utilized, a location corresponding to a protruding portion 31A of a fingerprint, which is brought in direct contact with transmission liquid-crystal plate 1, gives off stronger light, and a location corresponding to an recessed portion 31B gives off weaker light. Therefore, protruding portions 31A are observed as bright parts, and recessed portions 31B are observed as dark parts.

As explained hereinabove, according to the present invention, it is possible to achieve a fingerprint recognition device, which can be made less costly and thinner, and which is capable of reading a fingerprint image with high contrast.

What is claimed is:

1. A fingerprint recognition device, comprising:
a window member on which a finger is placed;
a first light source device for generating a light, which is irradiated onto a finger placed on said window member;
a liquid-crystal plate for sequentially allowing light from a finger placed on said window member to pass through one pixel at a time by sequentially shifting the location of an aperture;
a light-collecting portion for collecting light from said liquid-crystal plate; and
a photodetector element for receiving light collected by said light-collecting portion, by pixel unit.

2. The fingerprint recognition device according to claim 1, wherein said liquid-crystal plate allows the passage of either light reflected by said finger, or light, which penetrates the inside of said finger and is diffused by the surface of said finger.

3. The fingerprint recognition device according to claim 1, wherein said window member has a light-guide plate the surface of which a finger is placed on, and which guides light, which is generated by said first light source device and enters inside this light-guide plate.

4. The fingerprint recognition device according to claim 3, wherein said light-guide plate has a substantially transparent gel-like thin-film layer on the surface where said finger is placed.

5. The fingerprint recognition device according to claim 1, further comprising storing means for storing the output of said photodetector element, by pixel unit, corresponding to the pixels of said liquid-crystal plate.

6. The fingerprint recognition device according to claim 1, wherein said liquid-crystal plate sequentially selects one arbitrary pixel from among a plurality of pixels arranged two-dimensionally as said aperture which allows light from said finger to pass through.

7. The fingerprint recognition device according to claim 1, wherein said liquid-crystal plate sequentially selects one arbitrary pixel from among a plurality of pixels arranged one-dimensionally as said aperture which allows light from said finger to pass through.

8. The fingerprint recognition device according to claim 1, further comprising a second light source device for generating light which is irradiated in a direction from said photodetector element toward said window member,
wherein said liquid-crystal plate displays an image by allowing light from said second light source device to pass through in the direction of said window member.

9. A fingerprint recognition method, comprising the steps of:
irradiating light on a finger placed on a window member;
allowing light from a finger placed on said window member to pass through sequentially one pixel at a time by sequentially shifting the location of an aperture of a liquid-crystal plate;
collecting light from said liquid-crystal plate; and
receiving collected light by pixel unit.
